(19) United States
(12) Patent Application Publication
(10) Pub. No.: US 2024/0428466 A1
(43) Pub. Date: Dec. 26, 2024

(54) METHOD AND APPARATUS FOR LIDAR POINT CLOUD CODING

(71) Applicants: HYUNDAI MOTOR COMPANY, SEOUL (KR); KIA CORPORATION, SEOUL (KR); DIGITALINSIGHTS INC., SEOUL (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); DIGITALINSIGHTS INC., SEOUL (KR)

(21) Appl. No.: 18/820,863

(22) Filed: Aug. 30, 2024

Related U.S. Application Data
(63) Continuation of application No. PCT/KR2023/002517, filed on Feb. 22, 2023.

(30) Foreign Application Priority Data
Mar. 21, 2022 (KR) 10-2022-0034737
Feb. 15, 2023 (KR) 10-2023-0020082

(51) Int. Cl. G06T 9/00

(52) U.S. Cl. CPC G06T 9/001

(57) ABSTRACT

A lidar point cloud coding method and apparatus convert a point cloud to video signals by using features of a lidar sensor to improve encoding efficiency of lidar point cloud coding. The lidar point cloud coding method and the apparatus encode/decode the converted video signals.

### CROSS REFERENCE TO RELATED APPLICATIONS

This application is a continuation of International Application No. PCT/KR2023/002517 filed on Feb. 22, 2023, which claims priority to and the benefit of Korean Patent Application No. 10-2022-0034737 filed on Mar. 21, 2022, and Korean Patent Application No. 10-2023-0020082, filed on Feb. 15, 2023, the entire contents of each of which are incorporated herein by reference.

### TECHNICAL FIELD

The present disclosure relates to a method and an apparatus for lidar point cloud coding.

### BACKGROUND

The statements in this section merely provide background information related to the present disclosure and do not necessarily constitute prior art.

Conventional lidar point cloud coding devices perform encoding/decoding of a lidar point cloud by using the same methods as other point clouds. However, lidar point clouds are characterized in that, due to the nature of lidar sensors, there are as many points as there are lidar sensors for a given time interval, while extractable from the path of the lidar's laser is a single point.

When a point cloud is acquired by using lidar in a typical automobile, the features of the lidar sensor may be represented as shown in the example of FIG. 1. In the example of FIG. 1, there are eight laser sensors of the lidar in a longitudinal direction. Each sensor can measure the distance from the laser source to an object and measure the reflection coefficient of the object. Additionally, from the perspective of observing from the top of the automobile, each sensor can measure the distance and reflection coefficient for a 360-degree area centered on the automobile. Depending on the specification of the lidar, if the maximum distance is exceeded, the reflection coefficient and distance are not measurable, each sensor may be disabled from generating a point. Further, when the lidar sensor is one-dimensional, the lidar sensor is supposed to be rotated 360 degrees to obtain points in all areas. When the lidar sensor is a two-dimensional model, the lidar sensor is adapted to be used in multiples to measure distance and reflection coefficient for a specific area.

Based on the measured distances as described above, the point cloud coding device may convert the acquired points into a Cartesian coordinate system in three-dimensional space to generate an ordinary point cloud, and may accordingly generate geometric information of the point cloud. At this time, the reflection coefficient of each point can be the attribute information of the point cloud. To improve the coding efficiency of such point cloud coding, there is a need to take the most advantage of the characteristics of the lidar sensor.

### SUMMARY

The present disclosure seeks to provide a lidar point cloud coding method and an apparatus for converting a point cloud to video signals by using features of a lidar sensor to improve the coding efficiency of lidar point cloud coding. The lidar point cloud coding method and the apparatus encode/decode the converted video signals.

At least one aspect of the present disclosure provides a method performed by a lidar point-cloud decoding device for decoding a lidar point cloud. The method includes reconstructing a lidar frame from a bitstream by using a video decoding method. The method also includes post-processing a reconstructed lidar frame. The method also includes constructing, from the post-processed lidar frame, the lidar point cloud with a converted coordinate system. The method also includes reconstructing the lidar point cloud by inversely converting the converted coordinate system of the lidar point cloud.

Another aspect of the present disclosure provides a method performed by a lidar point-cloud encoding device for encoding a lidar point cloud. The method includes converting a coordinate system of geometric information of the lidar point cloud. The method also includes generating a lidar frame from the lidar point cloud converted by the coordinate system. The method also includes preprocessing the lidar frame. The method also includes encoding a preprocessed lidar frame by using a video encoding method.

Yet another aspect of the present disclosure provides a computer-readable recording medium storing a bitstream generated by a method for encoding a lidar point cloud. The method includes converting a coordinate system of geometric information of the lidar point cloud. The method also includes generating a lidar frame from the lidar point cloud converted by the coordinate system. The method also includes preprocessing the lidar frame. The method also includes encoding a preprocessed lidar frame by using a video encoding method.

As described above, the present disclosure provides a lidar point cloud coding method and an apparatus for converting a point cloud to video signals by using features of a lidar sensor. The lidar point cloud coding method and the apparatus encode/decode the converted video signal. Thus, the lidar point cloud coding method and the apparatus improve the coding efficiency of lidar point cloud coding.

### BRIEF DESCRIPTION OF THE FIGURES

FIG. 1 is a diagram illustrating the features of a lidar sensor.

FIG. 2 is a block diagram of a lidar point-cloud encoding device according to at least one embodiment of the present disclosure.

FIG. 3 is a diagram illustrating a lidar frame converted from a lidar point cloud, according to at least one embodiment of the present disclosure.

FIG. 4 is a block diagram of a lidar point-cloud decoding device according to at least one embodiment of the present disclosure.

FIG. 5 is a block diagram of a lidar point cloud-encoding device using segmentation, according to at least one embodiment of the present disclosure.

FIG. 6 is a block diagram of a lidar point-cloud decoding device using segmentation, according to at least one embodiment of the present disclosure.

FIG. 7 is a diagram illustrating uniform segmentation and corresponding packing, according to at least one embodiment of the present disclosure.

FIG. 8 is a diagram illustrating a uniform segmentation and subsequent packing, according to another embodiment of the present disclosure.

FIG. 9 is a diagram illustrating non-uniform segmentation and subsequent packing, according to another embodiment of the present disclosure.

FIG. 10 is a diagram illustrating a uniform segmentation and subsequent packing, according to yet another embodiment of the present disclosure.

FIG. 11 is a flowchart of a method performed by an encoding device for encoding a lidar point cloud, according to at least one embodiment of the present disclosure.

FIG. 12 is a flowchart of a method performed by a decoding device for decoding a lidar point cloud, according to at least one embodiment of the present disclosure.

FIG. 13 is a flowchart of a method performed by the encoding device for encoding a lidar point cloud, according to another embodiment of the present disclosure.

FIG. 14 is a flowchart of a method performed by the decoding device for decoding a lidar point cloud, according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

The present disclosure in some embodiments provides a lidar point cloud coding method and an apparatus. More specifically, the present disclosure provides a lidar point cloud coding method and an apparatus that utilize features of a lidar sensor to convert a point cloud to video signals. The lidar point cloud coding method and the apparatus encode/decode the converted video signals.

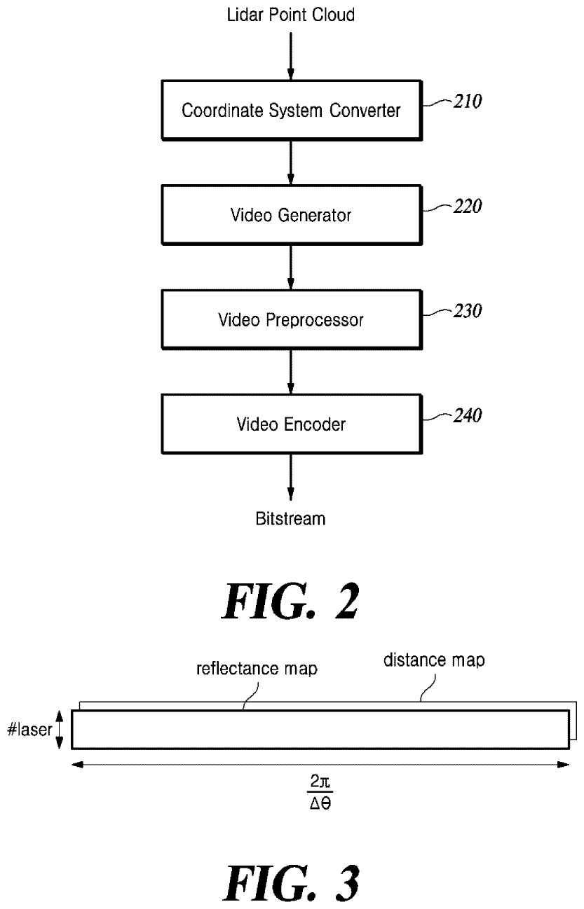

FIG. 2 is a block diagram of a lidar point cloud encoding device according to at least one embodiment of the present disclosure.

A lidar point cloud encoding device (hereinafter used interchangeably with ‘encoding device’) according to at least one embodiment of the present disclosure converts a lidar point cloud into video signals and then encodes the converted video signals. The encoding device may include all or part of a coordinate system converter 210, a video generator 220, a video preprocessor 230, and a video encoder 240.

The coordinate system converter 210 receives the lidar point cloud and converts the coordinate system of the geometric information of the lidar point cloud. At this time, if the input coordinate system is a Cartesian coordinate system, the coordinate system converter 210 may convert the coordinate system of the geometric information to a cylindrical coordinate system or a spherical coordinate system. Further, when a world coordinate system is used, the coordinate system converter 210 may perform the step of converting to a frame coordinate system. The lidar point cloud with a converted coordinate system may be transferred to the video generator 220.

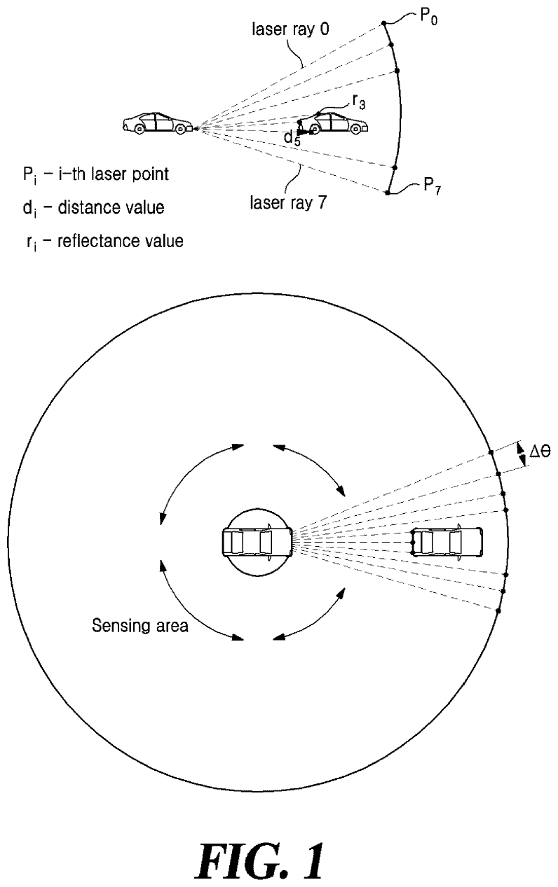

In one example, the lidar point cloud may be acquired by a plurality of lidar sensors attached to an automobile, such as in the example of FIG. 1.

The video generator 220 receives the lidar point cloud with the converted coordinate system to generate a video. In one example, if the lidar point cloud uses a spherical coordinate system, the video generator 220 may sample the lidar point cloud based on the lidar sensor's index and sampling angle, and then may project distance values and reflection coefficients to an index and rotation angle plane of the lidar sensors to generate an image, i.e., a lidar frame.

FIG. 3 is a diagram illustrating a lidar frame converted from a lidar point cloud, according to at least one embodiment of the present disclosure.

The lidar frame may have a vertical or longitudinal length equivalent to the number of lidar sensors, and a horizontal or transverse length equivalent to 360 degrees divided by the sampling angle (Δθ), as shown in the example of FIG. 3. In the example of FIG. 3, #laser indicates the number of lidar sensors. Further, the lidar frame may have multiple channels, one of which may be a distance map indicating the distance from the sensor to the object from which the point was acquired. Another channel may be a reflectance map of the object from which the points were acquired. The generated lidar frame may be transferred to the video preprocessor 230.

The video preprocessor 230 performs preprocessing for video encoding on the generated lidar frame. Here, the preprocessing may be filtering to remove noise. Alternatively, the preprocessing may be padding to conform to the input for the video encoder 240. Alternatively, the preprocessing may be scaling to conform to the bit depth of the input to the video encoder 240. The video preprocessor 230 may transfer the preprocessed lidar frame to the video encoder 240. Alternatively, the video preprocessor 230 may split each channel of the lidar frame into separate frames to generate one or more frames, and then may encode each frame by using a separate video encoder.

The video encoder 240 encodes the inputted lidar frames to generate a bitstream. The video encoder 240 may use a video coding method such as H.264/AVC (Advanced Video Coding), H.265/HEVC (High Efficiency Video Coding), H.266/VVC (Versatile Video Coding), VP8, VP9, AV1, or the like. The generated bitstream may be outputted.

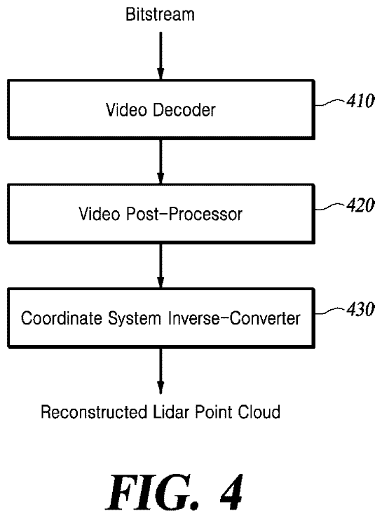

FIG. 4 is a block diagram of a lidar point-cloud decoding device according to at least one embodiment of the present disclosure.

A lidar point-cloud decoding device (hereinafter used interchangeably with ‘decoding device’) reconstructs a lidar point cloud by receiving a bitstream as input. The decoding device may include all or part of a video decoder 410, a video post-processor 420, and a coordinate system inverse-converter 430.

The video decoder 410 decodes the inputted bitstream to reconstruct a lidar frame. The reconstructed lidar frame may be transferred to the video post-processor 420.

The video post-processor 420 receives and then post-processes the reconstructed lidar frame. The post-processing is equivalent to a reverse process of the pre-processing performed in the encoding device by the video preprocessor 230. In this case, if a filtering process has been performed by the video preprocessor 230, the post-processing may be omitted.

Further, the video post-processor 420 performs the reverse process of the video generator 220. The video post-processor 420 constructs a lidar point cloud from the post-processed lidar frame. The lidar point cloud with the coordinate system converted may be transferred to the coordinate system inverse-converter 430.

The coordinate system inverse-converter 430 receives the lidar point cloud with the converted coordinate system and reconstructs the lidar point cloud by inversely converting the converted coordinate system. At this time, the coordinate system inverse-converter 430 may perform the reverse process of the coordinate system conversion done by the coordinate system converter 210 in the encoding device. The reconstructed lidar point cloud may be outputted.

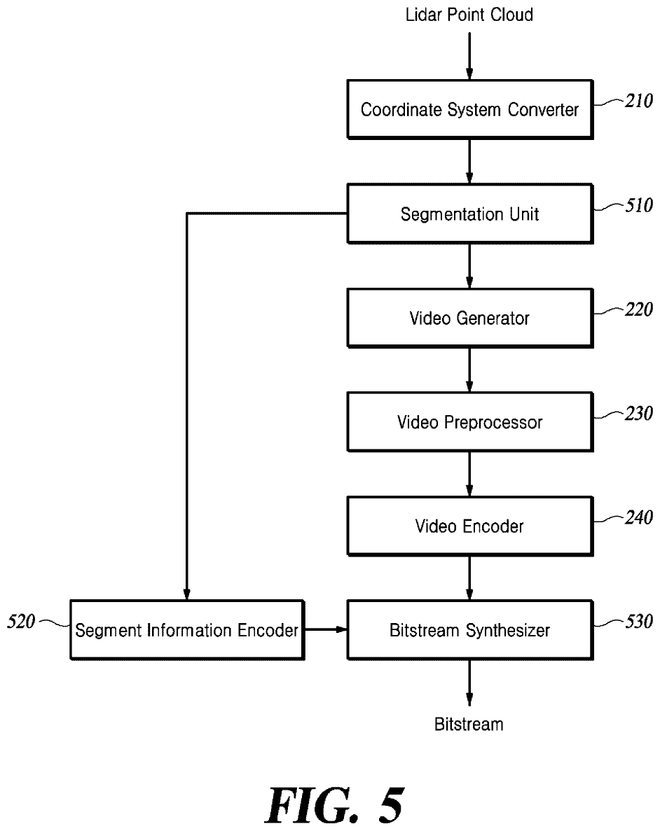

FIG. 5 is a block diagram of a lidar point cloud-encoding device using segmentation, according to at least one embodiment of the present disclosure.

The lidar point-cloud encoding device using segmentation receives input of a lidar point cloud and encodes the lidar point cloud to generate a bitstream. The encoding device may include all or part of a coordinate system converter 210, a segmentation unit 510, a video generator 220, a video preprocessor 230, a video encoder 240, a segment information encoder 520, and a bitstream synthesizer 530.

The coordinate system converter 210 may receive the lidar point cloud as input and then may convert the coordinate system of the geometric information of the lidar point cloud. In this case, if the inputted coordinate system is a Cartesian coordinate system, the coordinate system converter 210 may convert the coordinate system of the geometric information to a cylindrical coordinate system or a spherical coordinate system. Further, when the world coordinate system is used, the coordinate system converter 210 may perform the step of converting to a frame coordinate system. The lidar point cloud with the converted coordinate system may be transferred to the segmentation unit 510.

The segmentation unit 510 splits the inputted lidar point cloud by a plurality of segments. The lidar point cloud segments may be transferred to the video generator 220. Further, the information used for segmentation may be transferred to the segment information encoder 520.

Upon receiving the lidar point cloud segments, the video generator 220 packs the lidar point cloud segments to generate a single lidar frame with the distance map and the reflectance map distinguished. The generated lidar frame may be transferred to the video preprocessor 230.

The video preprocessor 230 may perform preprocessing for video encoding on the generated lidar frame. Here, the preprocessing may be filtering to remove noise. Alternatively, the preprocessing may be padding to conform to the input for the video encoder 240. Alternatively, the preprocessing may be scaling to conform to the bit depth of the input to the video encoder 240. The preprocessed lidar frame may be transferred to the video encoder 240.

The video encoder 240 encodes the input lidar frames to generate the first bitstream as a video bitstream. The video encoder 240 may use a video coding method such as H.264/AVC, H.265/HEVC, H.266/VVC, VP8, VP9, AV1, or the like. The generated first bitstream may be transferred to the bitstream synthesizer 530.

Meanwhile, the segment information encoder 520 encodes the segment information received from the segmentation unit 510 to generate a second bitstream as a segment information bitstream. The generated second bitstream may be transferred to the bitstream synthesizer 530.

The bitstream synthesizer 530 concatenates the first bitstream and the second bitstream to generate a final bitstream. The generated final bitstream may be outputted.

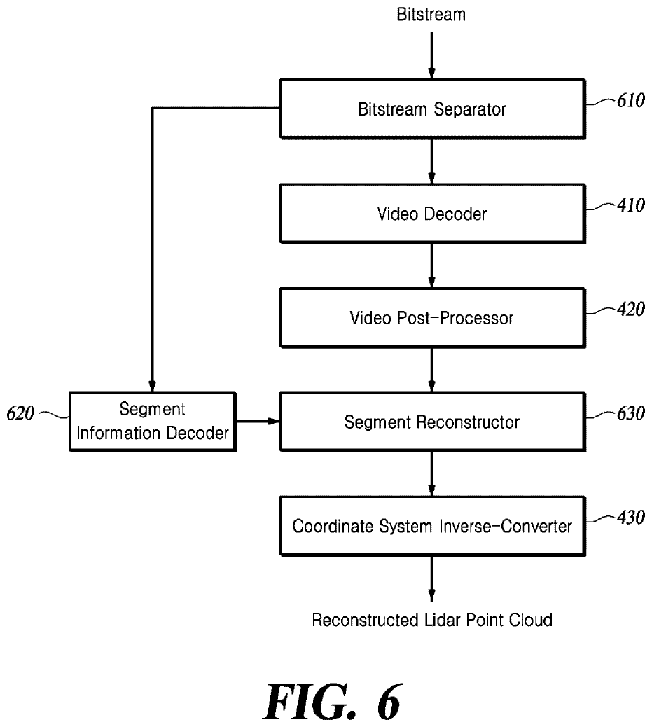

FIG. 6 is a block diagram of a lidar point-cloud decoding device using segmentation, according to at least one embodiment of the present disclosure.

A lidar point-cloud decoding device using segmentation reconstructs a lidar point cloud by receiving bitstream input. The decoding device may include all or part of a bitstream separator 610, a video decoder 410, a video post-processor 420, a segment information decoder 620, a segment reconstructor 630, and a coordinate system inverse-converter 430.

The bitstream separator 610 separates the inputted bitstream into a video bitstream and a segment information bitstream, i.e., a first bitstream and a second bitstream. The first bitstream may be transferred to the video decoder 410. Further, the second bitstream may be transferred to the segment information decoder 620.

The video decoder 410 decodes the inputted video bitstream to reconstruct a lidar frame. The reconstructed lidar frame may be transferred to the video post-processor 430.

The video post-processor 420 receives and then post-processes the reconstructed lidar frame. The post-processing corresponds to a reverse process of the preprocessing performed in the encoding device by the video preprocessor 230. In this case, if a filtering process has been performed in the video preprocessor 230, the post-processing may be omitted.

Further, the video post-processor 420 performs the reverse process of the video generator 220. The video post-processor 420 constructs a lidar point cloud per segment from the post-processed lidar frame. The lidar point cloud per segment may be transferred to the segment reconstructor 630.

The segment information decoder 620 reconstructs the segment information by decoding the inputted segment information bitstream. The segment information decoder 620 may transfer the reconstructed segment information to the segment reconstructor 630.

The segment reconstructor 630 receives and then uses the lidar point cloud by each segment and the reconstructed segment information to reconstruct the lidar point cloud. The lidar point cloud with the converted coordinate system may be transferred to the coordinate system inverse-converter 430.

The coordinate system inverse-converter 430 receives the lidar point cloud with the converted coordinate system, and then inversely converts the converted coordinate system to reconstruct the lidar point cloud. At this time, the coordinate system inverse-converter 430 may perform the reverse process of the coordinate system conversion performed by the coordinate system converter 210 of the encoding device. The reconstructed lidar point cloud may be outputted.

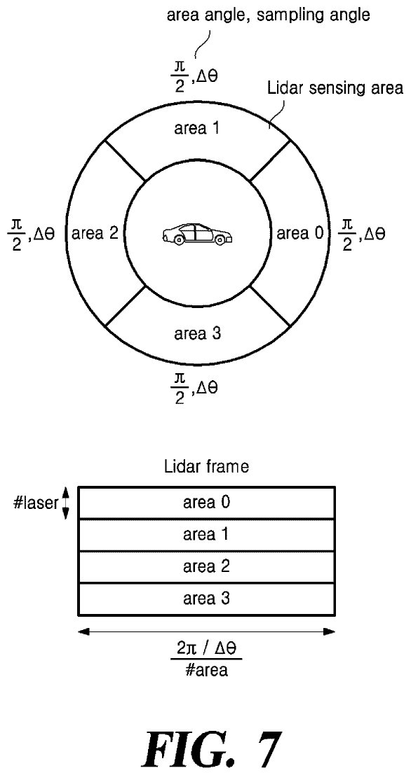

Hereinafter, a segmentation method and a packing method of the segments thereof are described with reference to FIGS. 7 through 10.

FIG. 7 is a diagram illustrating uniform segmentation and corresponding packing, according to at least one embodiment of the present disclosure.

The segmentation unit 510 may split the lidar-sensible area with a uniform area angle into segments, and the video generator 220 may pack the segments into a rectangular frame. In the example of FIG. 7, the segmentation unit 510 splits a 360-degree area into four uniform segments, and the video generator 220 vertically arranges the lidar point cloud amounting to respective segments to pack the arrangement into a rectangular lidar frame. When segments are packed into the lidar frame, the video generator 220 may assign an index to each segment and may pack the segments sequentially according to the index. Further, the segment reconstructor 630 may sequentially reconstruct the split areas according to the segment-wise indexes.

In the example of FIG. 7, #area indicates the number of segments according to a uniform area angle.

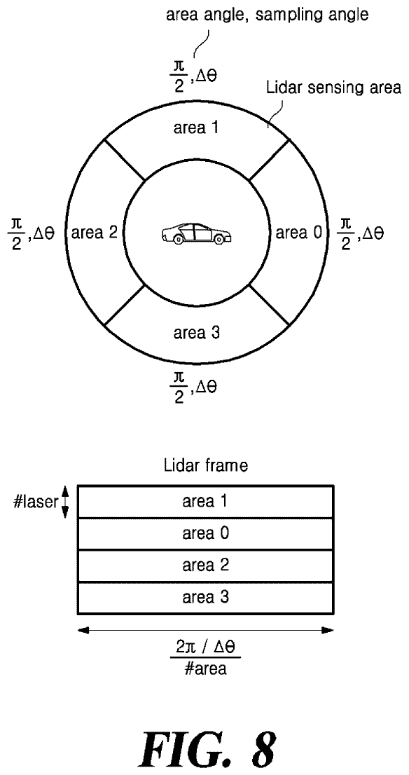

FIG. 8 is a diagram illustrating a uniform segmentation and subsequent packing, according to another embodiment of the present disclosure.

In the example of FIG. 8, the segmentation unit 510 splits a 360-degree region into four uniform segments, and the video generator 220 vertically arranges the lidar point cloud amounting to the respective segments to pack the arrangement into a rectangular lidar frame. Since the front and rear of the automobile are more significant areas than the sides, the video generator 220 may center the segments representing the front and rear of the automobile in the vertical arrangement in the lidar frame. This can reduce the effect of distortion due to compression during encoding.

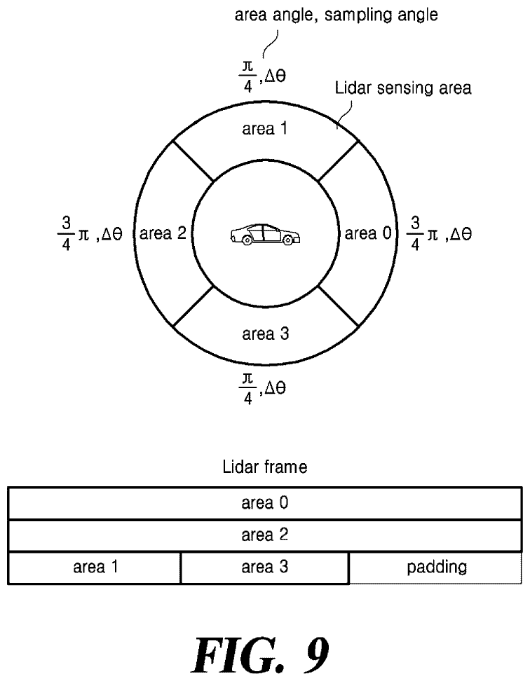

FIG. 9 is a diagram illustrating non-uniform segmentation and subsequent packing, according to another embodiment of the present disclosure.

The segmentation unit 510 may generate segments by splitting the lidar-sensible area with non-uniform area angles, and the video generator 220 may pack the segments into a rectangular frame. Large areas need to be sensed for the front and rear of the automobile. In view of this, the segmentation unit 510 may split the lidar-sensible area according to non-uniform area angles, as shown in the example of FIG. 9. The video generator 220 may process a large area in the front or a large area in the back as a single unit, and may pack the remaining portions into the bottom of the frame. In this case, by encoding the large area in the front or a large area in the back as a single unit, the encoding efficiency of intra/inter prediction can be improved.

The video preprocessor 230 may apply padding to voids that may occur due to non-uniform segmentation. As a padding method, the video preprocessor 230 may use the nearest pixel value. Alternatively, an intermediate value based on the bit depth utilized by the video encoder 240 may be used. Alternatively, a push-pull padding method may be used.

Here, the push-pull padding method performs a hierarchical down-sampling on the target frame, a hierarchical up-sampling on the target frame, and then combines the foreground region with the up-sampled background region in the same hierarchy. The push-pull padding method may improve video encoding efficiency by smoothing edge regions attributable to the foreground texture packed on a patch-by-patch basis.

As described above, information about each segment length may be encoded by the segment information encoder 520 in the encoding device. In this case, symmetry may be utilized instead of encoding all of the information. The encoding device may transfer half of the information to the decoding device, and the decoding device may use the received segment information and symmetry to reconstruct the remaining segment information.

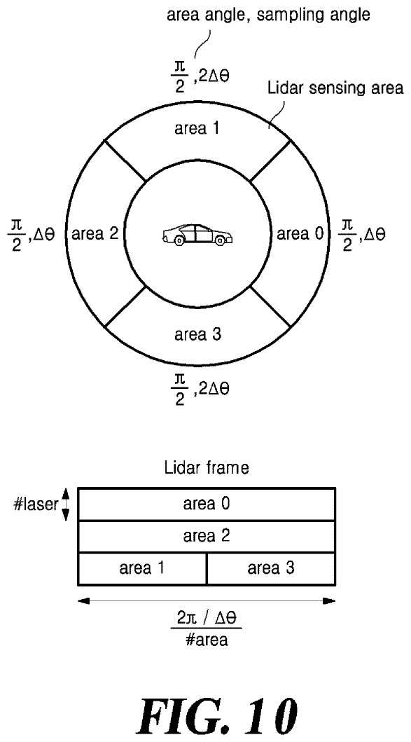

FIG. 10 is a diagram illustrating a uniform segmentation and subsequent packing, according to yet another embodiment of the present disclosure.

As illustrated in FIG. 10, the segmentation unit 510 splits the lidar-sensible area by using a uniform area angle to generate segments, and the video generator 220 may apply a different sampling angle to each segment during the video generation step. Because the front and rear of the automobile may contain relatively significant information, the video generator 220 may use a relatively small sampling angle for the front and rear of the automobile and a large sampling angle for the remaining segments. The video generator 220 may generate a lidar frame by vertically arranging the segments with a smaller sampling angle, with the remaining segments at the bottom. Accordingly, the video generator 220 may generate a lidar frame that has the same size but contains different information items.

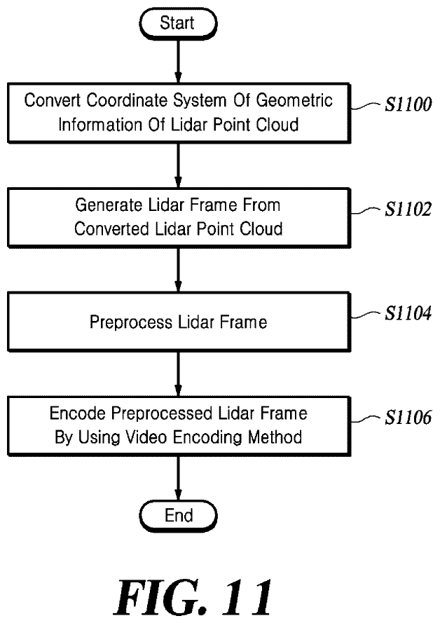

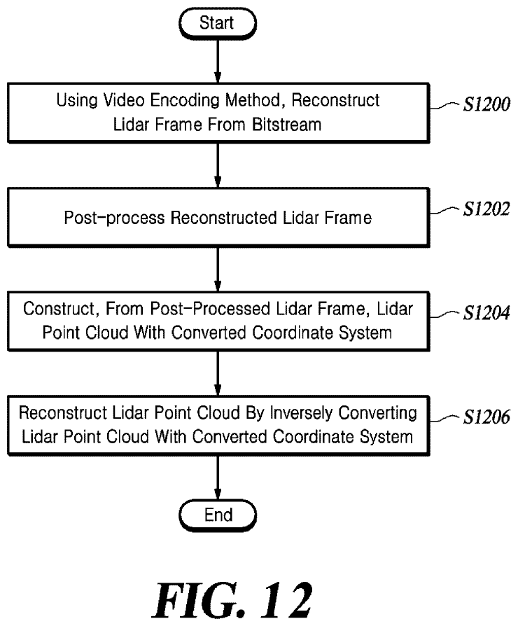

Referring now to FIGS. 11 and 12, a method of encoding/decoding a lidar point cloud is described.

FIG. 11 is a flowchart of a method performed by the encoding device for encoding a lidar point cloud, according to at least one embodiment of the present disclosure.

The encoding device converts a coordinate system of geometric information of the lidar point cloud (S1100).

The encoding device generates a lidar frame from the converted lidar point cloud (S1102).

In one example, if the lidar point cloud uses a spherical coordinate system, the encoding device may sample the lidar point cloud based on the index and sampling angle of the lidar sensors, and then may project the distance values and reflection coefficients of the sampled points to an index and rotation angle plane of the lidar sensors, thereby generating a lidar frame with the distance map and the reflectance map distinguished.

The lidar frame may have a longitudinal length based on the number of lidar sensors, and a transverse length based on 360 degrees divided by the sampling angle.

The encoding device preprocesses the lidar frame (S1104).

Here, the preprocessing may be filtering to remove noise. Alternatively, the preprocessing may be padding to make it suitable for the input form of the video encoding. Alternatively, the preprocessing may be scaling to conform to the bit depth of the input of the video encoding.

The encoding device encodes the preprocessed lidar frame by using a video encoding method (S1106). The encoding device may utilize video encoding methods such as H.264/AVC, H.265/HEVC, H.266/VVC, VP8, VP9, AV1, and the like.

FIG. 12 is a flowchart of a method performed by the decoding device for decoding a lidar point cloud, according to at least one embodiment of the present disclosure.

The decoding device reconstructs a lidar frame from the bitstream by using a video decoding method (S1200). The decoding device may use a video decoding method, such as H.264/AVC, H.265/HEVC, H.266/VVC, VP8, VP9, AV1, or the like.

The decoding device post-processes the reconstructed lidar frame (S1202).

The post-processing may be the reverse of the pre-processing performed by the encoding device. For example, the decoding device may remove padding or scaling applied by the encoding device. In this case, if a filtering process has been performed by the encoding device, the post-processing may be omitted.

The post-processed lidar frame may have a longitudinal length based on the number of lidar sensors and a transverse length based on 360 degrees divided by the sampling angle.

The decoding device constructs a lidar point cloud with a converted coordinate system from the post-processed lidar frame (S1204).

The decoding device may use a distance map and a reflectance map included in the post-processed lidar frame to construct a lidar point cloud with the converted coordinate system. The distance map and the reflectance map may be generated by the encoding device by sampling the lidar point cloud based on the index and sampling angle of the lidar sensors, and then projecting the distance values and reflection coefficients of the sampled points to an index and rotation angle plane of the lidar sensors.

The decoding device inversely converts the converted coordinate system of the lidar point cloud to reconstruct the lidar point cloud (S1206).

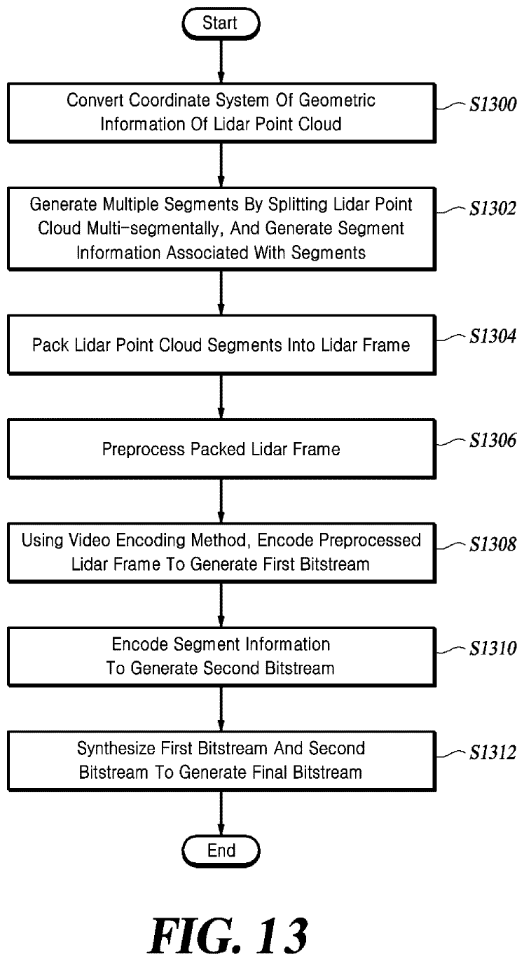

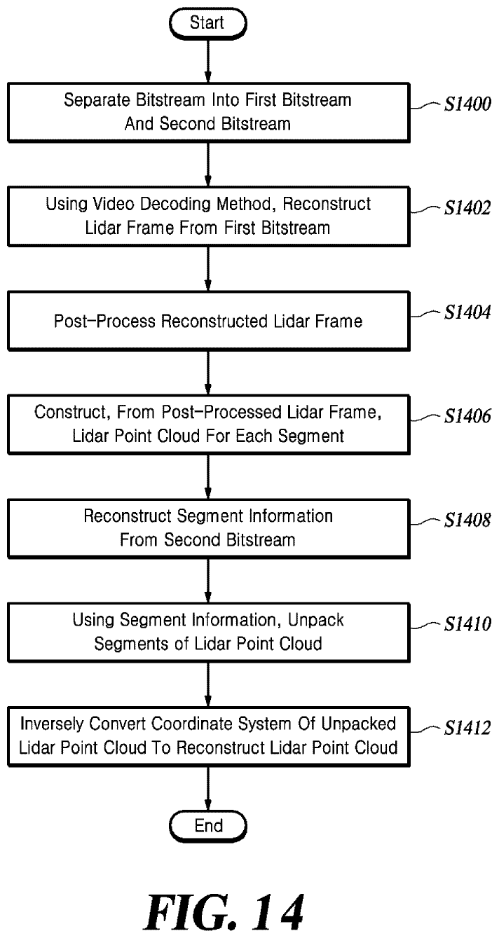

Referring now to FIGS. 13 and 14, a method of encoding/decoding a lidar point cloud that uses segmentation is described.

FIG. 13 is a flowchart of a method performed by the encoding device for encoding a lidar point cloud, according to another embodiment of the present disclosure.

The encoding device converts a coordinate system of geometric information of the lidar point cloud (S1300).

The encoding device generates a plurality of segments by splitting the lidar point cloud multi-segmentally and generates segment information associated with the segments (S1302).

The encoding device may split the lidar-sensible area by using a uniform area angle to generate the segments and may generate segment information associated with the segments.

Alternatively, the encoding device may split the lidar-sensible area by using non-uniform area angles based on the significance of the respective segments to generate non-uniform segments and may generate segment information associated with the non-uniform segments.

The encoding device packs the lidar point cloud segments into a lidar frame (S1304).

In one example, if the lidar point cloud uses the spherical coordinate system, the encoding device may sample the lidar point cloud based on the index and sampling angle of the lidar sensors, and then may project the distance values and reflection coefficients of the sampled points to an index and rotation angle plane of the lidar sensors, thereby generating a lidar frame with the distance map and the reflectance map distinguished.

The encoding device may arrange the segments vertically to pack the segments into a lidar frame, as in the example of FIG. 7, while adjusting the order of packing the segments according to the significance of each segment, as in the example of FIG. 8.

Alternatively, the encoding device may vary the sampling angle applied to each segment according to the significance of each segment, as shown in the example of FIG. 10.

Alternatively, the encoding device may apply padding to voids that occur when packing non-uniform segments, as in the example of FIG. 9.

The packed lidar frame may have a longitudinal length based on the number of lidar sensors and the number of segments, and a transverse length based on each segment divided by the sampling angle.

The encoding device preprocesses the packed lidar frame (S1306).

Here, the preprocessing may be filtering to remove noise. Alternatively, the preprocessing may be padding to conform to the input form of the video encoding. Alternatively, the preprocessing may be scaling to conform to the bit depth of the input of the video encoding.

The encoding device encodes the preprocessed lidar frames by using a video encoding method to generate the first bitstream (S1308). The encoding device may use a video encoding method such as H.264/AVC, H.265/HEVC, H.266/VVC, VP8, VP9, AV1, or the like.

The encoding device encodes the segment information to generate the second bitstream (S1310).

The encoding device synthesizes the first bitstream and the second bitstream to generate a final bitstream (S1312).

FIG. 14 is a flowchart of a method performed by the decoding device for decoding a lidar point cloud, according to another embodiment of the present disclosure.

The decoding device separates the bitstream into a first bitstream and a second bitstream (S1400). Here, the first bitstream includes a lidar frame and the second bitstream includes segment information associated with segments of the lidar point cloud.

The decoding device reconstructs a lidar frame from the first bitstream by using a video decoding method (S1402). The decoding device may use a video decoding method such as H.264/AVC, H.265/HEVC, H.266/VVC, VP8, VP9, AV1, or the like.

The decoding device post-processes the reconstructed lidar frame (S1404).

The post-processing may be the inverse of the pre-processing performed by the encoding device. For example, the decoding device may remove any padding or scaling applied by the encoding device. In this case, if a filtering process has been performed by the encoding device, the post-processing may be omitted.

The post-processed lidar frame may have a longitudinal length based on the number of lidar sensors and the number of segments, and a transverse length based on each segment divided by a sampling angle.

The decoding device constructs a lidar point cloud for each segment from the post-processed lidar frame (S1406).

The decoding device may use a distance map and a reflectance map included in the lidar frame to construct the lidar point cloud with the converted coordinate system. The distance map and the reflectance map may be generated by the encoding device by sampling the lidar point cloud based on the index and sampling angle of the lidar sensors, and then projecting the distance values and reflection coefficients of the sampled points to an index and rotation angle plane of the lidar sensors.

The decoding device reconstructs segment information from the second bitstream (S1408).

Here, the segment information is information associated with segments generated by splitting the lidar-sensible area by using a uniform area angle. Alternatively, the segment information may be information associated with non-uniform segments generated by splitting the lidar-sensible area by using non-uniform region angles.

The decoding device uses the segment information to unpack the segments of lidar point cloud (S1410).

Based on the examples of FIGS. 7 and 8, the decoding device may unpack the vertically arranged segments, taking into account the order of the segments packed, according to the significance of each segment.

Further, based on the example of FIG. 10, the decoding device may unpack the segments by taking into account a sampling angle applied differently according to the significance of each segment.

Further, the decoding device may remove padding applied by the encoding device to fill voids caused by packing the non-uniform segments, based on the example of FIG. 9.

The decoding device reconstructs the lidar point cloud by inversely converting the converted coordinate system of the unpacked lidar point cloud (S1412).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a lidar point-cloud decoding device for decoding a lidar point cloud, the method comprising:
reconstructing a lidar frame from a bitstream by using a video decoding method;
post-processing a reconstructed lidar frame;
constructing, from the post-processed lidar frame, the lidar point cloud with a converted coordinate system; and
reconstructing the lidar point cloud by inversely converting the converted coordinate system of the lidar point cloud.

2. The method of claim 1, wherein post-processing the reconstructed lidar frame includes:
removing padding or scaling applied by a lidar point-cloud encoding device.

3. The method of claim 1, wherein the lidar frame has a longitudinal length based on a number of lidar sensors, and a transverse length based on 360 degrees divided by a sampling angle.

4. The method of claim 3, wherein constructing the lidar point cloud includes:
constructing the lidar point cloud with the converted coordinate system, by using a distance map and a reflectance map contained in the lidar frame;
wherein the distance map and the reflectance map are generated by a lidar point-cloud encoding device by sampling the lidar point cloud based on an index and a sampling angle of the lidar sensors, and then projecting distance values and reflection coefficients of sampled points to an index and rotation angle plane of the lidar sensors.

5. A method performed by a lidar point-cloud encoding device for encoding a lidar point cloud, the method comprising:
converting a coordinate system of geometric information of the lidar point cloud;
generating a lidar frame from the lidar point cloud converted by the coordinate system;
preprocessing the lidar frame; and
encoding a preprocessed lidar frame by using a video encoding method.

6. The method of claim 5, wherein generating the lidar frame includes, when the lidar point cloud uses a spherical coordinate system, generating the lidar frame by distinguishing between a distance map and a reflectance map by sampling the lidar point cloud based on an index and a sampling angle of lidar sensors, and then projecting distance values and reflection coefficients of sampled points to an index and rotation angle plane of the lidar sensors.

7. The method of claim 6, wherein the lidar frame has a longitudinal length based on a number of the lidar sensors and a transverse length based on 360 degrees divided by the sampling angle.

8. The method of claim 5, wherein preprocessing the lidar frame includes applying padding, or scaling, to the lidar frame to make the lidar frame suitable for encoding the preprocessed lidar frame.

9. A computer-readable recording medium storing a bitstream generated by a method for encoding a lidar point cloud, the method comprising:
converting a coordinate system of geometric information of the lidar point cloud;
generating a lidar frame from the lidar point cloud converted by the coordinate system;
preprocessing the lidar frame; and
encoding a preprocessed lidar frame by using a video encoding method.
